(19) United States
(12) Patent Application Publication
(10) Pub. No.: US 2026/0248263 A1
(43) Pub. Date: Aug. 27, 2026

(54) DEODORANT CONTAINER

(71) Applicant: VERITIV PACKAGING SOLUTIONS, Buena Park, CA (US)

(72) Inventors: Chris Bradley, Buena Park, CA (US); Alan Crarer, Santa Cruz, CA (US)

(21) Appl. No.: 19/552,906

(22) Filed: Feb. 27, 2026

Related U.S. Application Data
(60) Provisional application No. 63/934,721, filed on Dec. 9, 2025.
(60) Provisional application No. 63/925,311, filed on Nov. 25, 2025.
(60) Provisional application No. 63/764,456, filed on Feb. 27, 2025.

(51) Int. Cl. A45D 40/04

(52) U.S. Cl. CPC A45D 40/04; A45D 2200/05

(57) ABSTRACT

A sustainable container for deodorant and cosmetic products having compostable and recyclable components to enable curbside recycling of the entire container is disclosed. The container has an interior cavity for storing the deodorant or other cosmetic material and housing an elevator mechanism for advancing the deodorant or other cosmetic material within the interior cavity towards the opening at the top end of the container for use. The elevator mechanism preferably includes a platform for holding and pushing the deodorant or other cosmetic material to be dispensed. The components may be coated, laminated, combined or otherwise treated with impermeable biodegradable materials to prevent absorption by the components and/or leakage of the deodorant material from the container and are not required to be separated from one another to be recycled in the mainstream.

### CROSS-REFERENCE TO RELATED APPLICATIONS

This application claims the benefit of priority to U.S. provisional application no. 63/764,456 filed February 27, 2025; U.S. provisional application no. 63/925,311 filed November 25, 2025; and U.S. provisional application no. 63/934,721 filed December 9, 2025, all of which are incorporated herein by reference in their entirety.

### BACKGROUND

The present invention relates to a sustainable container that is compostable, repulpable, recyclable, and, more specifically, sustainable containers for dispensing deodorant, balm, sunscreen, cosmetics, and similar products wherein the container is manufactured from primarily paper-based material and in part from Polyhydroxyalkanoates (PHA), Polyhydroxybutyrate (PHB), or other similar home compostable materials that can be injection molded or otherwise moldable. The weight ratio of the paper to PHA component is such that it is repulpable and recyclable. The small PHA parts are fully compostable. This combination of paper parts and small PHA parts gives the deodorant container of the present invention a unique sustainability profile. It means that the deodorant container can be both recyclable and home compostable, and far simpler to manufacture than existing deodorant containers intended to be sustainable. If the entire container was made all out of PHA then it would be compostable but would be too expensive to be commercially practical.

Polyhydroxyalkanoates or PHAs are polyesters produced in nature by numerous microorganisms, including through bacterial fermentation of sugars or lipids. When produced by bacteria they serve as both a source of energy and as a carbon store. More than 150 different monomers can be combined within this family to give materials with extremely different properties. These materials are compostable. These materials are biodegradable. PHA can be reused. It can be recycled back to the polymer for new applications. It can be recycled back to raw materials to be used as renewable feedstock. It can be recycled to the environment through industrial or home composting. It can be recycled through incineration creating renewable energy. And lastly, it can be recycled to nutrients for living organisms through full biodegradation.

It is appreciated that PHA is technically not a plastic or a bioplastic; although some might call it that because of its moldability properties. PHA is created by microbes so it is a moldable bio-based material that can be molded like plastic, but it is microbial in origin. A product including PHA can be plastic free which is highly desirable for a sustainable package. It is intended to be within the scope of the present invention, that the small parts of the container be made of PHA, PHB, biodegradable biopolymer, or other similar moldable material that is home compostable.

The packaging of common deodorant sticks to control body odor and/or perspiration is mainly made of plastic products, which are not entirely recyclable by the processes utilized in curbside recycling, are not home compostable, and are not biodegradable. Previous attempts at making the deodorant containers out of recyclable materials had defects including, for example, properly advancing the deodorant material from the container and leakage of the deodorant material from the container. There is a need for a plastic-free deodorant or balm container that is both recyclable and home compostable.

A key aspect of recycling fiber materials is the requirement to pass repulpability standards, such as those set by Western Michigan University (WMU) or the Fibre Box Association. These pulpability standards ensure that paper-based products can be efficiently broken down into their original fibers during the recycling process. The repulpability standards assess whether a material can disintegrate into a pulp without leaving behind any large, unrecyclable fragments or contaminants that could hinder the recycling process. To be recyclable in the paper recycling stream, at least 85% by weight of the entire package must be recoverable fibers through the repulping process. This means that the PHA parts must be less than 15% of the total package weight.

There is a need for a deodorant container that is fully recyclable by curbside recycling, repulpable and home compostable, and that is easy to use, prevents leakage of the deodorant material, can withstand repetitive usage, and overcomes deficiencies of existing deodorant container systems. More specifically, there is a need for a deodorant container that is primarily paper based that may be recycled easily in the existing paper recycling stream with minimal non-paper parts that also are easily biodegradable, recyclable curbside or home compostable. Such a deodorant container preferably is made of paper-based materials with an inner liner or a coating. But otherwise, it is made of PHA, PHB and/or other compostable moldable materials including all aspects of the internal mechanisms for dispensing the deodorant material from the container. The configuration of the deodorant container could be scaled to any size suitable for the intended purpose.

### SUMMARY

The present invention is directed to a sustainable container manufactured from entirely recyclable, repulpable, and home compostable materials to enable curbside recycling of the entire container.

In an embodiment, the container is a deodorant container having a body portion with a top end and an opposite bottom end. The top end is open and provides access to an interior cavity for storing the deodorant material. The top end can be closed with a cap to protect the contents of interior cavity. The bottom end is configured to rotate to operate a mechanism for dispensing the deodorant material from within the interior cavity.

The interior cavity of the container includes an elevator mechanism for advancing the deodorant material within the interior cavity towards the opening at the top end of the container for use. The elevator mechanism preferably includes a platform for holding and pushing the deodorant material to be dispensed. The platform includes a threaded aperture. A spindle is threadably engaged via threads to the threaded aperture and operates to move the platform along the length of the spindle when the spindle is rotated via a lower base. The platform and the spindle are preferably made of PHA, PHB or other similar moldable biocompostable materials.

In an embodiment, a sustainable deodorant container being compostable and recyclable, the deodorant container comprising:

a body having a wall defining an interior cavity, a top end, and an opposite bottom end, the top end being open and providing access to the interior cavity for receiving and storing a deodorant material, the wall being made of a paper-based material being at least one of repulpable and recyclable, the wall having an outer surface and an inner surface for contacting the deodorant material placed within the interior cavity, the inner surface including an impermeable biomaterial to prevent the deodorant material from penetrating the body;

a cap for closing the top end to protect the deodorant material contained within the interior cavity, the cap being made of the paper-based material and including an inner surface for contacting the deodorant material within the interior cavity, the inner surface of the cap including the impermeable biomaterial to prevent the deodorant material from penetrating the cap;

an elevator mechanism in the interior cavity for advancing the deodorant material within the interior cavity towards the opening at the top end of the container to dispense the deodorant material, the elevator mechanism including a platform for holding and pushing the deodorant material to be dispensed, the platform including a threaded aperture, the platform being made of a Polyhydroxyalkanoates (PHA)material being compostable and has a surface for contacting the deodorant material;

a spindle threadbly engaging the threaded aperture and operating to move the platform along the length of the spindle when the spindle is rotated, the spindle being made of the PHA material and is compostable; and

a dial at the bottom end of the body, the dial being connected to an end of the spindle and is used to rotate the spindle to operate the elevator mechanism for dispensing the deodorant material from within the interior cavity, the dial being made of the PHA material and is compostable.

The deodorant container, wherein the impermeable biomaterial of the inner surface of the body includes at least one of PHA, (PHB (Polyhydroxybutyrate), PHBV (Polyhydroxybutyrate-co-valerate), PHO (Polyhydroxyoctanoate), copolymers, and microbially synthesized polymers.

The deodorant container, wherein the impermeable biomaterial of the inner surface of the body includes at least one of a natural, biodegradable wax, oil, and sealant to prevent absorption of the deodorant material.

The deodorant container, wherein the paper-based material is at least approximately 80% to 85% by weight of the total weight of the deodorant container and the PHA material is less than approximately 15% to 20% by weight of the total weight of the deodorant container.

The deodorant container, wherein the paper-based material includes recoverable fibers through a repulping process.

The deodorant container, wherein the paper-based materials of the body include at least one of cardboard, corrugated cardboard, and cellulose with at least a portion of the paper-based material preferably being made from postconsumer paper.

The deodorant container, wherein the deodorant material is hydrous, and the impermeable biomaterial prevents penetration of the deodorant material into the body.

The deodorant container, wherein the deodorant material is anhydrous, and the impermeable biomaterial prevents penetration of the deodorant material into the body.

The deodorant container, wherein the PHA material includes at least one of PHB (Polyhydroxybutyrate), PHBV (Polyhydroxybutyrate-co-valerate), biodegradable biopolymer, PHO (Polyhydroxyoctanoate), microbially synthesized polymers, and/or materials that are recyclable, compostable, and/or repulpable to enable curbside recycling/home composting.

The deodorant container, wherein the spindle includes threads with a square-cut configuration and widely spaced apart to preserve a relatively smoothe surface of the spindle between troughs of the threads, the square-cut threads threadably engage the threaded aperture of platform and engage the deodorant material resulting in the advancement of the platform and deodorant material from within container when the spindle is rotated.

The deodorant container, where various components of the deodorant container comprise at least one of coated, laminated, combined or treated with the impermeable biodegradable materials to prevent absorption by the components and leakage of the deodorant material from the container.

In an embodiment, a cosmetic product container being compostable and recyclable, the cosmetic product container comprising:

a body having a wall defining an interior cavity, a top end, and an opposite bottom end, the top end being open and providing access to the interior cavity for storing a cosmetic material, the cosmetic material being a solid or semi-solid formulation, the wall being made of a paper-based material being at least one of repulpable and recyclable and includes an inner surface contacting the cosmetic material within the interior cavity, the inner surface including an impermeable biomaterial to prevent the cosmetic material from penetrating the body;

a cap for closing the top end to protect the cosmetic material contained within the interior cavity, the cap being made of the paper-based material and including an inner surface for contacting the cosmetic material within the interior cavity, the inner surface of the cap including an impermeable biomaterial to prevent the cosmetic material from penetrating the cap;

an elevator mechanism in the interior cavity for advancing the cosmetic material within the interior cavity towards the opening at the top end of the container to dispense the cosmetic material, the elevator mechanism including a platform for holding and pushing the cosmetic material to be dispensed, the platform including a threaded aperture, the platform being made of a Polyhydroxyalkanoates (PHA) material being compostable and has a surface for contacting the cosmetic material;

a spindle threadbly engaging the threaded aperture and operating to move the platform along the length of the spindle when the spindle is rotated, the spindle being made of the PHA material that is compostable; and

a dial at the bottom end of the body, the dial being connected to an end of the spindle and is used to rotate the spindle to operate the elevator mechanism for dispensing the cosmetic material from within the interior cavity, the dial being made of the PHA material that is compostable.

The cosmetic product container, wherein the impermeable biomaterial of the inner surface of the body includes at least one of PHA, (PHB (Polyhydroxybutyrate), PHBV (Polyhydroxybutyrate-co-valerate), PHO (Polyhydroxyoctanoate), copolymers, and microbially synthesized polymers.

The cosmetic product container, wherein the impermeable biomaterial of the inner surface of the body includes at least one of a natural, biodegradable wax, oil, and sealant to prevent absorption of the cosmetic material.

The cosmetic product container, wherein the paper-based material is at least approximately 80% to 85% by weight of the total weight of the cosmetic product container and the PHA material is less than approximately 15% to 20% by weight of the total weight of the cosmetic product container.

The cosmetic product container, wherein the paper-based material includes recoverable fibers through a repulping process.

The cosmetic product container, wherein the cosmetic material is hydrous, and the impermeable biomaterial prevents penetration of the cosmetic material into the body of the cosmetic product container.

The cosmetic product container, wherein the cosmetic material is anhydrous, and the impermeable biomaterial prevents penetration of the deodorant material into the body of the cosmetic product container.

The cosmetic product container, wherein the PHA material includes at least one of PHB (Polyhydroxybutyrate), PHBV (Polyhydroxybutyrate-co-valerate), biodegradable biopolymer, PHO (Polyhydroxyoctanoate), microbially synthesized polymers, and/or materials that are recyclable, compostable, and/or repulpable to enable curbside recycling/home composting.

The cosmetic product container, wherein the spindle includes threads with a square-cut configuration and widely spaced apart to preserve a relatively smoothe surface of the spindle between troughs of the threads, the square-cut threads threadably engage the threaded aperture of platform and engage the cosmetic material resulting in the advancement of the platform and cosmetic material from within container when the spindle is rotated.

The materials of the deodorant containers of the present invention are not required to be separated from one another to be recycled in the mainstream. Materials used include paper, for example cardboard, corrugated cardboard, and PHA, PHB and/or other moldable biocompostable materials with at least a portion of the paper materials preferably being made from postconsumer paper. The various components of the deodorant container may be coated, laminated, combined or otherwise treated with biodegradable materials to prevent absorption by the components and/or leakage of the deodorant material from the container.

A novel aspect of the present invention is the combination of the materials in certain weights. For example, by keeping the amount of PHA below 15% of the total weight of the container, then that makes the container recyclable in the paper recycling stream and WMU repulpable. By making it from paper and PHA this makes it home compostable.

While the container of the present invention is described herein as a deodorant container, other containers for dispensing any solid formulation including lip balms, sunscreen, foundation or makeup are intended to be within the scope of the present invention. Also, while an embodiment of the container is shown as having an oval cross section, it is appreciated that the container also be generally cylindrical or have any other configuration and cross-sectional shape suitable for the intended purpose. The cap structure could be of various shapes and sizes such as circular, square or rectangular for example.

These as well as still further features, objects and benefits of the invention will now become clear upon a review of the following detailed description of illustrative embodiments, taken in conjunction with the accompanying drawings.

### BRIEF DESCRIPTION OF THE DRAWINGS

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1 is a front elevation view of the deodorant container in accordance with an embodiment of the present invention, the rear elevation view being a mirror image thereof;

FIG. 2 is an exploded front perspective view of the deodorant container of FIG. 1;

FIG. 3 is a cross-sectional view of the deodorant container of FIG. 1;

FIG. 4 is a front perspective view of the base of the deodorant container of FIG. 1;

FIG. 5 is an exploded front perspective view of the base of the deodorant container of FIG. 1;

FIG. 6 is a cross-sectional view of the base of the deodorant container of FIG. 1;

FIG. 7 is a front perspective view of the body of the deodorant container of FIG. 1;

FIG. 8 is an exploded front perspective view of the body of the deodorant container of FIG. 1;

FIG. 9 is a cross-sectional view of the body of the deodorant container of FIG. 1;

FIG. 10 is a front perspective view of the cap of the deodorant container of FIG. 1;

FIG. 11 is an exploded front perspective view of the cap of the deodorant container of FIG. 1;

FIG. 12 is a cross-sectional view of the cap of the deodorant container of FIG. 1;

FIG. 13 is a front perspective view of the spindle of the elevation mechanism of the deodorant container of FIG. 1;

FIG. 14 is a front elevational view of the spindle of the elevation mechanism of the deodorant container of FIG. 1;

FIG. 15 is a top plan view of the spindle of the elevation mechanism of the deodorant container of FIG. 1;

FIG. 16 is a bottom plan view of the spindle of the elevation mechanism of the deodorant container of FIG. 1;

FIG. 17 is a cross-sectional view of the spindle of the elevation mechanism of the deodorant container of FIG. 1;

FIG. 18 is a top perspective view of the snap of the elevation mechanism of the deodorant container of FIG. 1;

FIG. 19 is a bottom perspective view of the snap of the elevation mechanism of the deodorant container of FIG. 1;

FIG. 20 top plan view of the snap of the elevation mechanism of the deodorant container of FIG. 1;

FIG. 21 is a bottom plan view of the snap of the elevation mechanism of the deodorant container of FIG. 1;

FIG. 22 is a side elevation view of the snap of the elevation mechanism of the deodorant container of FIG. 1;

FIG. 23 is a cross-sectional view of the snap of the elevation mechanism of the deodorant container of FIG. 1;

FIG. 24 is a bottom perspective view of the platform of the elevation mechanism of the deodorant container of FIG. 1;

FIG. 25 is a top perspective view of the platform of the elevation mechanism of the deodorant container of FIG. 1;

FIG. 26 is a top plan view of the platform of the elevation mechanism of the deodorant container of FIG. 1;

FIG. 27 is a bottom plan view of the platform of the elevation mechanism of the deodorant container of FIG. 1;

FIG. 28 is a side elevation view of the platform of the elevation mechanism of the deodorant container of FIG. 1;

FIG. 29 is a cross-sectional view of the platform of the elevation mechanism of the deodorant container of FIG. 1;

FIG. 30 is a top perspective view of the plate stop of the elevation mechanism of the deodorant container of the present invention;

FIG. 31 is a bottom perspective view of plate stop of the elevation mechanism of the deodorant container of FIG. 1;

FIG. 32 is a top plan view of the plate stop of the elevation mechanism of the deodorant container of FIG. 1;

FIG. 33 is a bottom plan view of the plate stop of the elevation mechanism of the deodorant container of FIG. 1;

FIG. 34 is a side elevation view of the plate stop of the elevation mechanism of the deodorant container of FIG. 1; and

FIG. 35 is a cross-sectional view of the plate stop of the elevation mechanism of the deodorant container of the present invention.

### DETAILED DESCRIPTION

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

The following disclosure provides many different embodiments, or examples, for implementing different features of the provided subject matter. Specific examples of components, concentrations, applications and arrangements are described below to simplify the present disclosure. These are, of course, merely examples and are not intended to be limiting, but on the contrary, the intention is to cover all modifications, equivalents, and alternatives falling within the spirit and scope of the present invention. For example, the attachment of a first feature and a second feature in the description that follows may include embodiments in which the first feature and the second feature are attached in direct contact and may also include embodiments in which additional features may be positioned between the first feature and the second feature, such that the first feature and the second feature may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The detailed description set forth below is intended as a description of various configurations of the present invention and is not intended to represent the only configurations in which the present invention may be practiced. Each example may be considered to be an embodiment and any reference to an “example” may be changed to “embodiment” in the present disclosure. It will be apparent, however, to those of ordinary skill in the art that the present invention is not limited to the specific details set forth herein and may be practiced without these specific details.

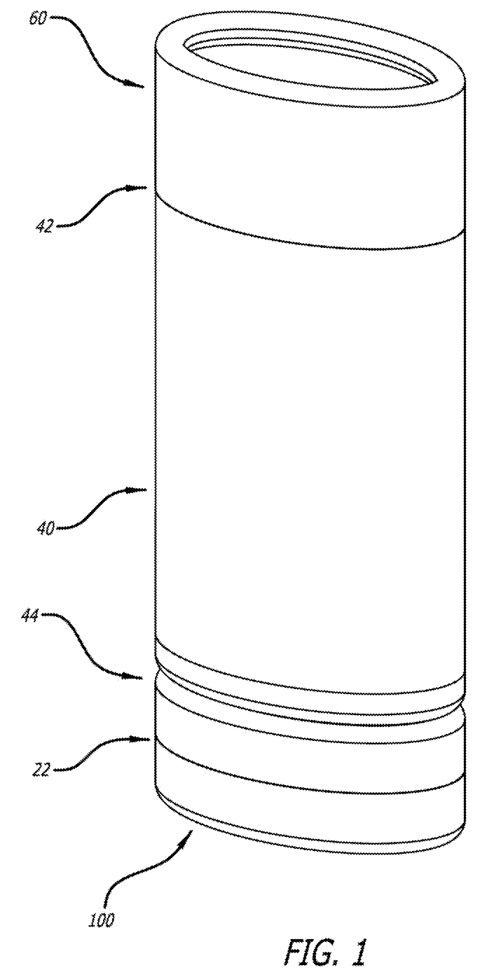

Referring to the Figures, FIG. 1 shows an embodiment of a sustainable deodorant container 100 manufactured from materials that are recyclable, compostable, and/or repulpable to enable curbside recycling/home composting of the entire container. Container 100 is configured for storing deodorant material or other cosmetic product material. It is appreciated that the material stored in container 100 need not be limited to a deodorant material or cosmetic product and may include a solid or semi-solid formulation that is hydrous and/or anhydrous, such as a deodorant, antiperspirant, foundation, sunscreen, and similar product.

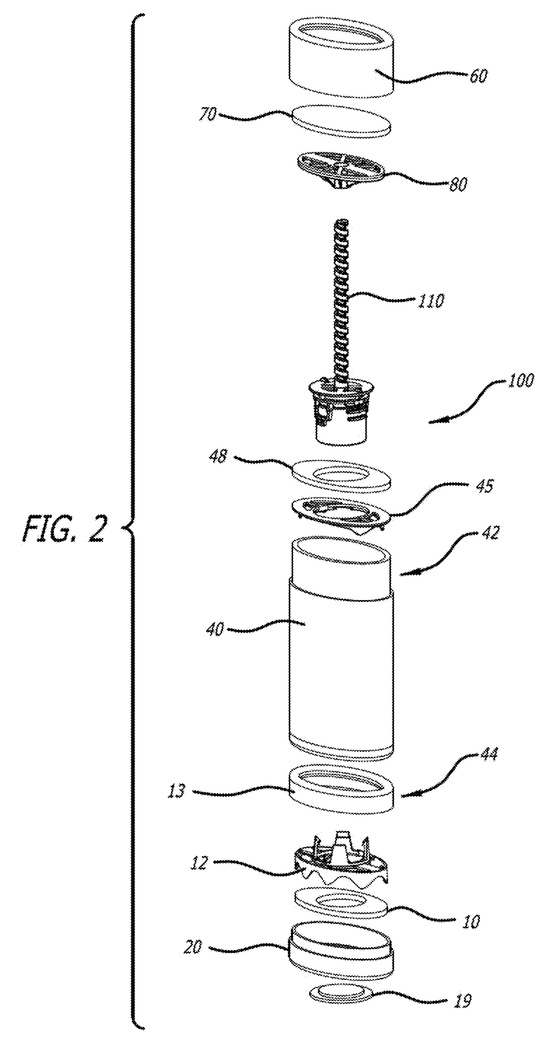

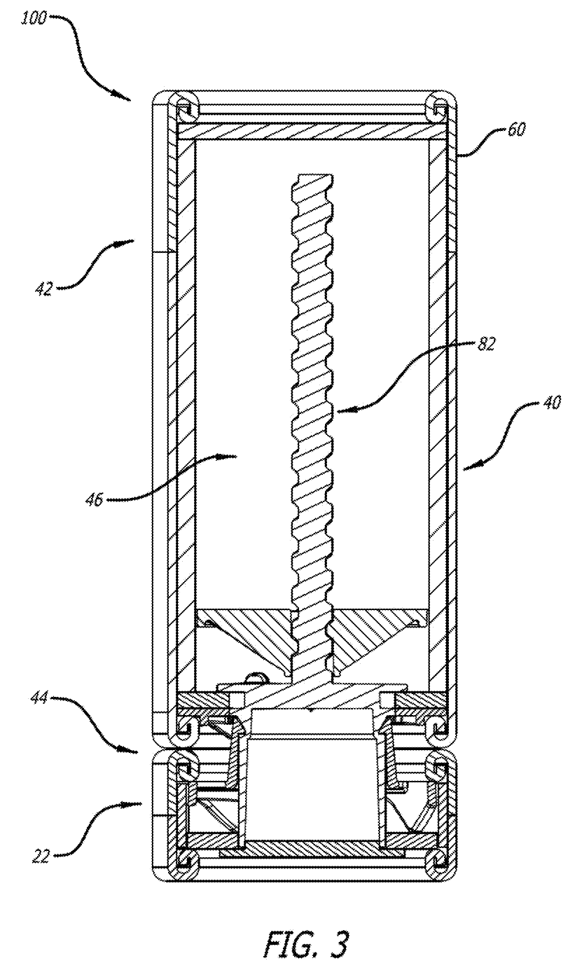

In an embodiment shown in FIGS. 1-3, container 100 has a body portion 40 with a top end 42 and an opposite bottom end 44. Top end 42 is open, as shown in FIG. 2, and provides access to an interior cavity 46, as shown in FIG. 3, for storing the deodorant material D.

Top end 42 is closeable with a removable cap 60. Bottom end 44 is configured to include a base portion 22 used to operate an elevator mechanism 82 for advancing and exposing the deodorant material from interior cavity 46 of container 100 to dispense the deodorant material from within interior cavity 46 for application by a user. Top end 42 can be closed with a cap 60 to protect the contents of interior cavity 46.

Interior cavity 46 of container 100 preferably includes elevator mechanism 82 for advancing the deodorant material from within interior cavity 46 towards the opening at top end 42 for use. Elevator mechanism 82 is preferably made of an assembly of components, each component being recyclable, repulpable, bio compostable, compostable, and/or biodegradable without synthetic plastics or other materials that are either not recyclable or would prevent the curbside recycling due to the presence of contaminants such as petroleum products or other synthetics for example.

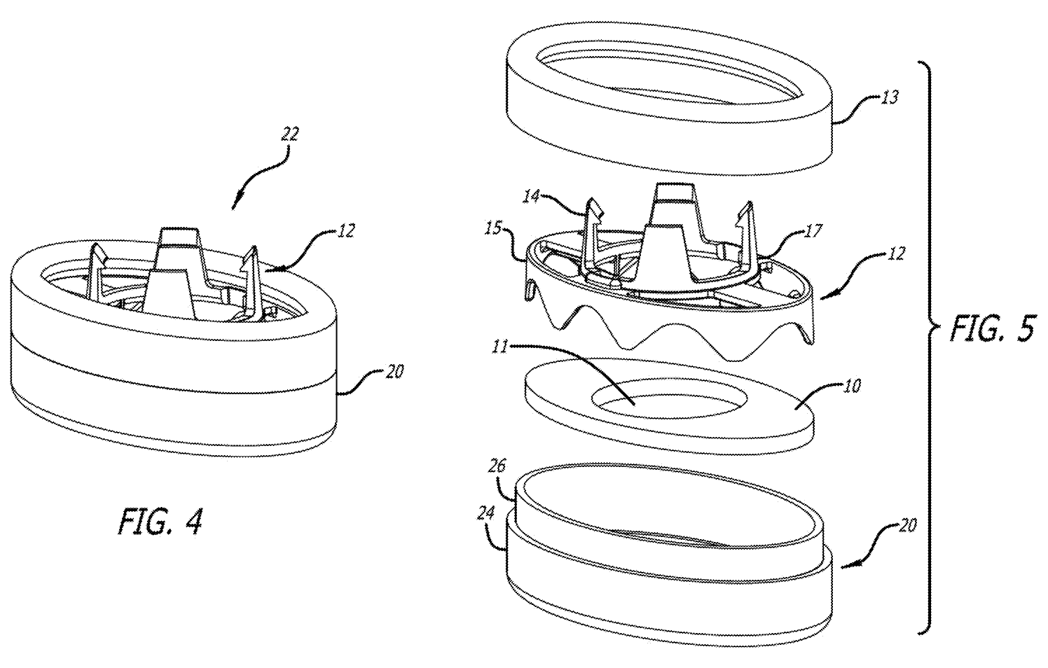

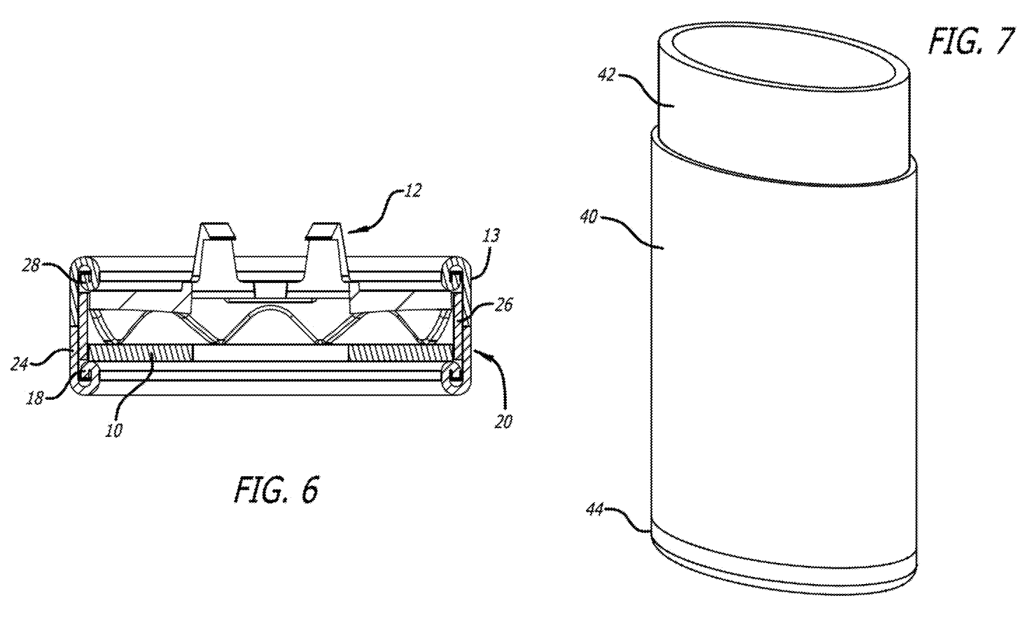

FIGS. 4-6 show an embodiment of base portion 22, which includes a lower base shell 20, a base plate 10, a snap 12, and an upper base shell 13. Lower base shell 20, base plate 10, and upper base shell 13 are preferably formed at least in part from a paper fiber material including wound paper fiber, cardboard, corrugated cardboard, and cellulose, with at least a portion of the materials preferably being made from postconsumer paper, and is repulpable and recyclable.

Lower base shell 20 is preferably configured with an outer ring 24 and an inner ring 26. In an embodiment, the bottom edge of outer ring 24 is rolled inward to form a hem 18. At least a portion of inner ring 26 is secured to outer ring 24 above hem 18 through pressure fitting, mechanical bonding, thermal bonding, and/or adhesive or other known methods or materials suitable for the intended purpose. It is appreciated that lower base shell 20 may be formed as a single piece, or configured to include additional components for its intended purpose.

Base plate 10 is formed as a flat ring with an opening 11. When base portion 22 is assembled, base plate 10 is configured to sit on top of hem 18 of outer ring 24. Base plate 10 may be secured to outer ring 24 through pressure fitting, mechanical bonding, thermal bonding, and/or adhesive or other known methods or materials suitable for the intended purpose.

Upper base shell 13 is a ring with a top edge rolled inward to form a hem 28. When base portion 22 is assembled, upper base shell 13 fits on top of lower base shell 20 and is secured through pressure fitting, mechanical bonding, thermal bonding, and/or adhesive or other known methods or materials suitable for the intended purpose. Inner ring 26 and hem 28 of upper base shell 13 may also create an interference fit. The fitting between upper base shell 13 and lower base shell 20 may also be sealed using one or more of the foregoing methods or materials.

Snap 12 is configured to fit within base portion 22, between upper base shell 13 and lower base shell 20. Preferably, when base portion 22 is assembled, snap 12 is held in place between hem 28 of upper base shell 13 and base plate 10. In an embodiment, snap 12 may be secured between upper base shell 13 and base plate 10 through pressure fitting, mechanical bonding, thermal bonding, and/or adhesive or other known methods or materials suitable for the intended purpose.

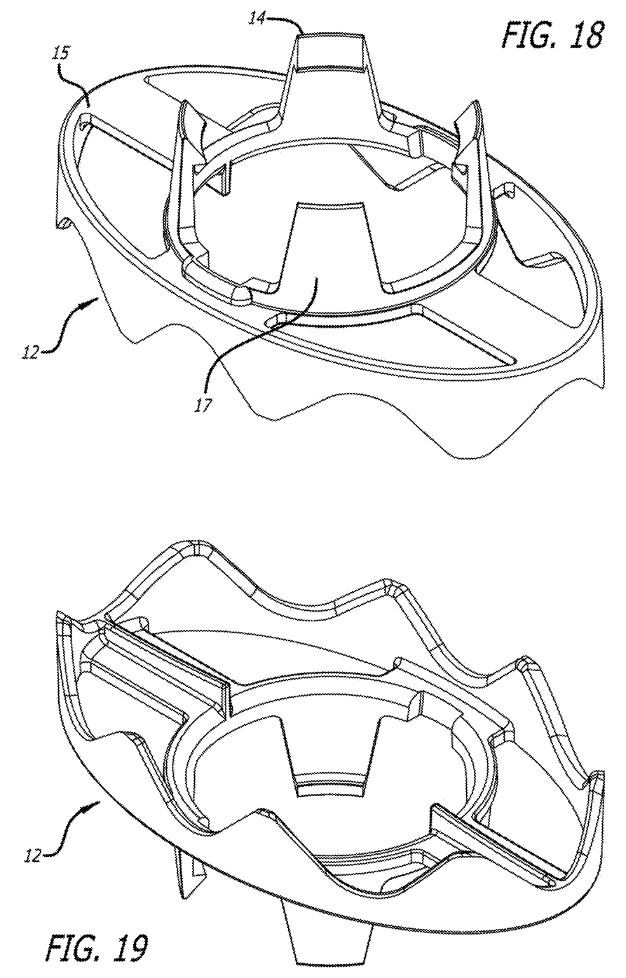

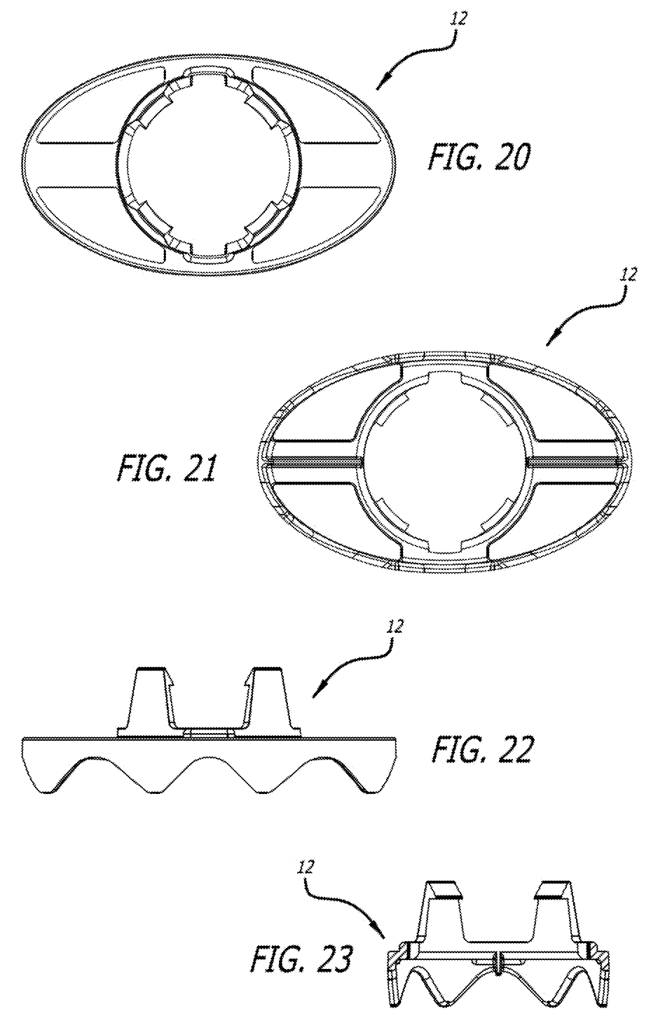

As shown in FIGS. 5-6 and 18-23, snap 12 includes a lower platform 15 and a locking portion 17 preferably made of PHA, PHB (Polyhydroxybutyrate), PHBV (Polyhydroxybutyrate-co-valerate), PHO (Polyhydroxyoctanoate), biodegradable biopolymer, and/or materials that are recyclable, compostable, and/or repulpable to enable curbside recycling/home composting of the entire container 100. Locking portion 17 is connected to lower platform 15 and configured to fully rotate while lower platform 15 remains fixed within lower base shell 20. Locking portion 17 is preferably configured with multiple arms 14 for receiving, securing, and enabling rotation of a spindle 110 to advance deodorant material toward top end 42 for use.

FIGS. 7-9 show an embodiment of body portion 40 with a seal 48 and a plate stop 45. Body portion 40 and seal 48 are preferably formed at least in part from a paper fiber material including wound paper fiber, cardboard, corrugated cardboard, and cellulose, with at least a portion of the materials preferably being made from postconsumer paper, and is repulpable and recyclable.

Body portion 40 is preferably configured with an outer portion 52 and an inner portion 54. In an embodiment, the bottom edge of outer portion 52 is rolled inward to form a hem 55. At least a part of inner portion 54 is secured to outer portion 52 above hem 55 through pressure fitting, mechanical bonding, thermal bonding, and/or adhesive or other known methods or materials suitable for the intended purpose. It is appreciated that body portion 40 may be formed as a single piece, or configured to include additional components for its intended purpose.

Body portion 40 has an inner surface 56 that is impermeable to prevent the deodorant material from penetrating the body. Preferably, inner surface 56 surrounding interior cavity 46 is coated, laminated, combined or otherwise treated with biodegradable materials to prevent absorption by the components and/or leakage of the deodorant material stored within interior cavity 46. In an embodiment, inner surface 56 of body portion 40 may include one or more impermeable liner 47 comprising a layer or coating or treatment of at least one impermeable material that is applied to and/or incorporated at least in body portion 40 to create an impermeable barrier to prevent leakage. One skilled in the art will appreciate that body portion 40 include a heat sealable liner, may be lined with one or more layers or combinations of paper, foil, and/or other materials to create an impermeable barrier to prevent leakage. Alternatively, a minimal layer of metallized polyethylene terephthalate (PET) can be used without significantly impacting the sustainability of a container in accordance with the present invention. Some examples of impermeable materials suitable for use in the containers in accordance with the present invention are set forth below, but not limited to the following:

### Liner Systems for Paper-Based Deodorant Packaging

In certain embodiments, a paper-based deodorant applicator comprises an internal liner selected from: (a) non-modified natural polymers; (b) chemically-modified natural polymers; (c) bio-synthesized or fermented polymers; (d) synthetic or modified polymer systems; and (e) micro-plastic free materials. The liner may be applied as a coating, dispersion, film, sleeve, insert, extrusion, or thermoformed structure, and provides resistance to moisture, oils, and fragrances compatible with deodorant formulations. Each category described herein may be used alone or in combination to create single-layer or multilayer barrier systems within a paper-based package.

### Section 1 — Natural, Non-Modified Polymer Liners

(Natural origin; not chemically altered; generally, not classified as plastics and more specifically not classified as “plastic” by the EU Single Use Plastic Directive)

Examples: Cellulose, nanocellulose, starch, alginate, agar, carrageenan, lignin, zein.

### Key attributes:

High biodegradability in soil and marine environments

Intrinsic grease and oil resistance, enhanced with densification or crosslinking

Moderate water barrier; tunable with multi-layer constructs

Compatible with paper recycling

Embodiments: Coated-paper liner, molded natural-polymer insert, spray-applied barrier layer.

### Section 2 — Chemically-Modified Natural Polymer Liners

Bio-derived polymers modified to improve water and vapor resistance

Examples: Cellulose acetate (CA), cellulose esters, CMC, HPMC.

### Key attributes:

Enhanced moisture and oxygen barrier properties

Thermoformable and extrudable

Adhesion compatibility with paper substrates

Biodegradable depending on degree of substitution

Embodiments: Extruded thin-wall liner, solvent-cast film laminated to paper, hybrid composite sleeve.

### Section 3 — Bio-Synthesized or Fermented Polymer Liners

Fermentation-derived polyesters; not chemically modified

Examples: PHA (PHB (Polyhydroxybutyrate), PHBV (Polyhydroxybutyrate-co-valerate), PHO (Polyhydroxyoctanoate), copolymers), other microbially synthesized polymers.

### Key attributes:

Strong oil and grease resistance

Broad biodegradation profile (home compost, industrial compost, soil, marine)

Processable via extrusion, injection molding, or coating

Can replace petroleum-based liners while maintaining form stability

Embodiments: Extruded PHA inner shell, thermoformed capsule, PHA-based coating on paper.

### Section 4 — Synthetic or Modified Polymer Liners (Petroplastic & Bioplastic Hybrids)

Used where maximum moisture barrier or dimensional stability is required

### Examples:

Petroplastics: PE, PP, PET, PVOH

Bioplastics: PLA, PBS, PBAT

### Key attributes:

High moisture, vapor, and fragrance-retention performance

Mature processing methods (extrusion, lamination, co-extrusion)

Compostability possible with certain grades (PLA, PBS, PBAT)

Useful in transitional or high-performance SKUs

Body portion 40 may be filled with deodorant material from top end 42 or bottom end 44 with seal 48 provided to further seal deodorant material within interior cavity 46. Seal 48 includes an opening 49 and is preferably shaped and configured to fit within outer portion 52 and below inner portion 54. It is appreciated that seal 48 may have alternative configurations to seal the deodorant material within interior cavity 46, such as being configured to fit within inner portion 54.

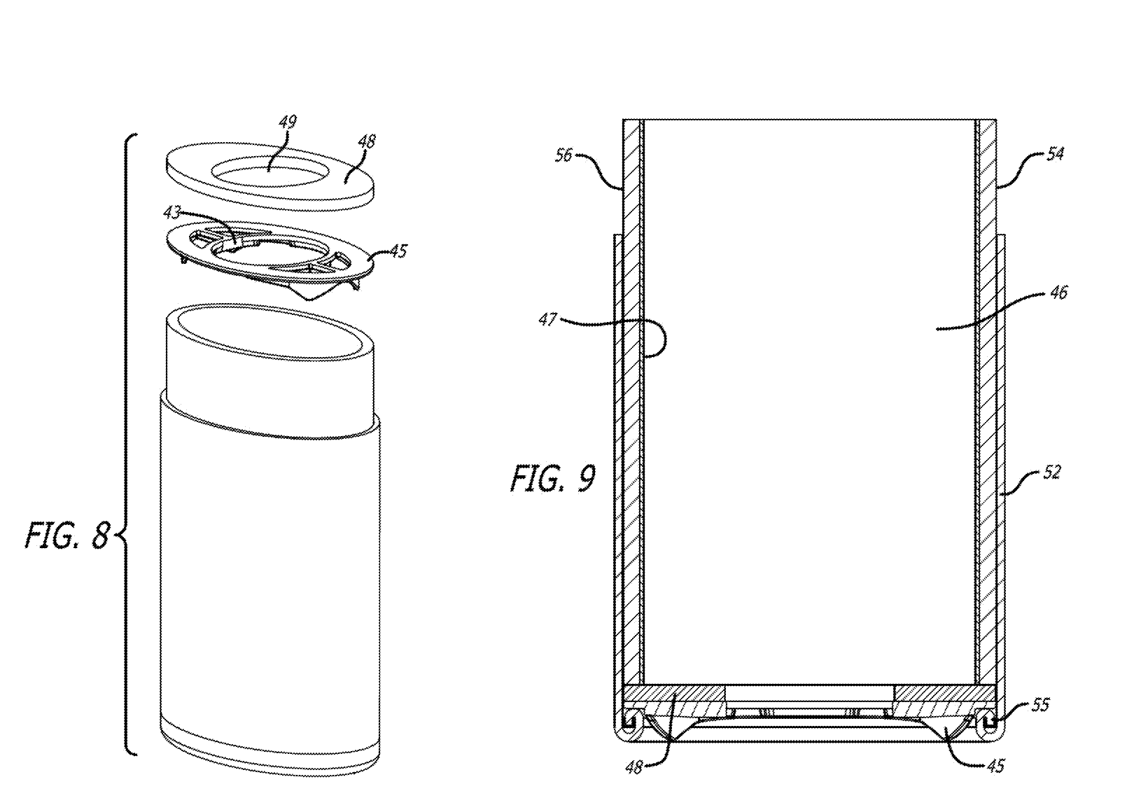

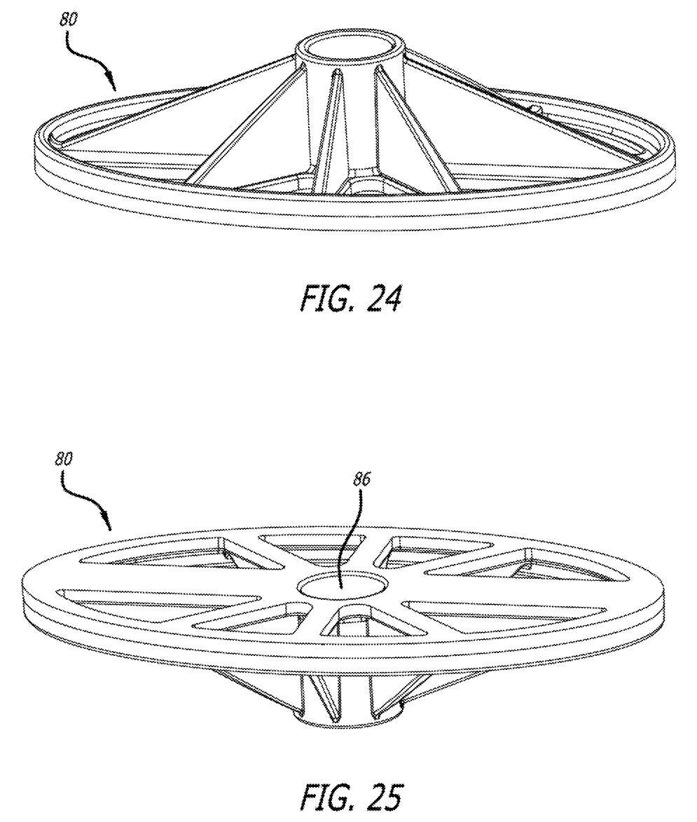

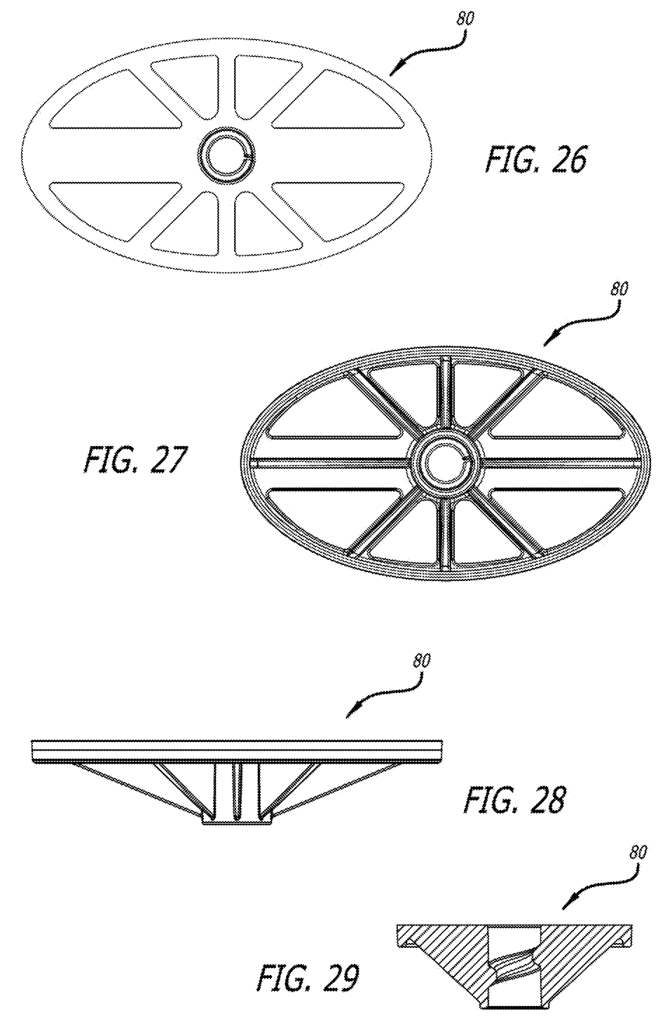

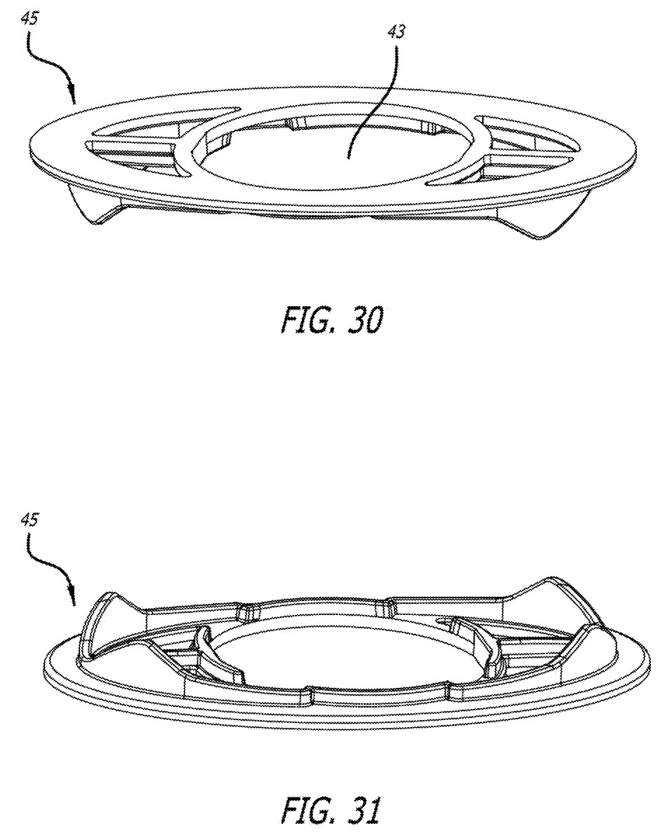

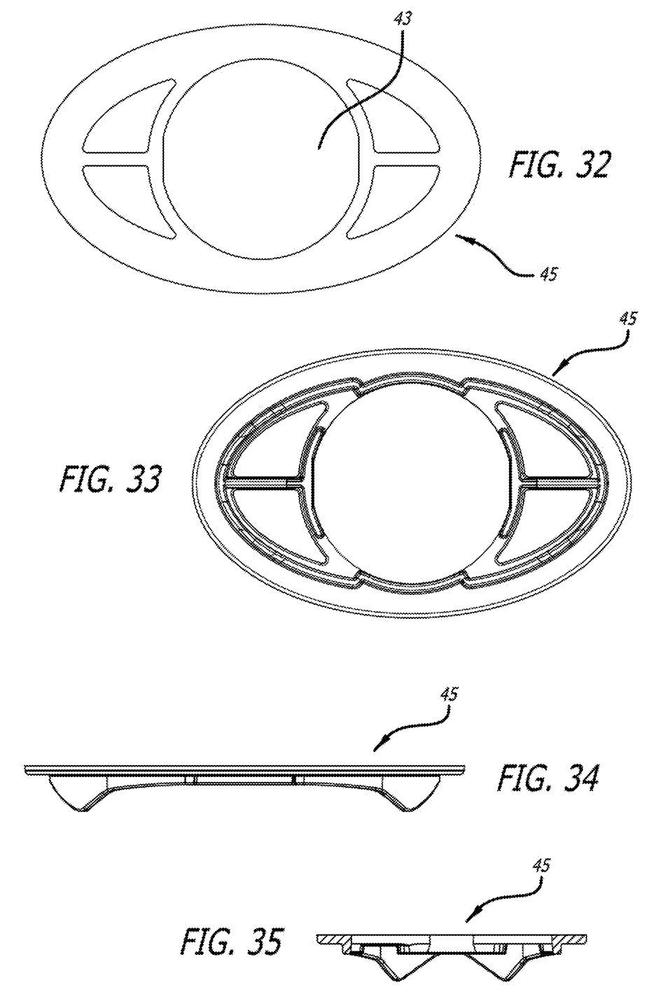

When body portion 40 is assembled, plate stop 45 is configured between seal 48 and hem 55 to resist the force trying to move spindle 110 through the bottom of interior cavity 46 as a platform 80 (shown in FIGS. 24-29) pushes the deodorant material upward. As shown in FIGS. 8-9 and 30-35, plate stop 45 is formed with an opening 43, and is preferably made of PHA, PHB and/or materials that are recyclable, compostable, and/or repulpable to enable curbside recycling/home composting of the entire container 100.

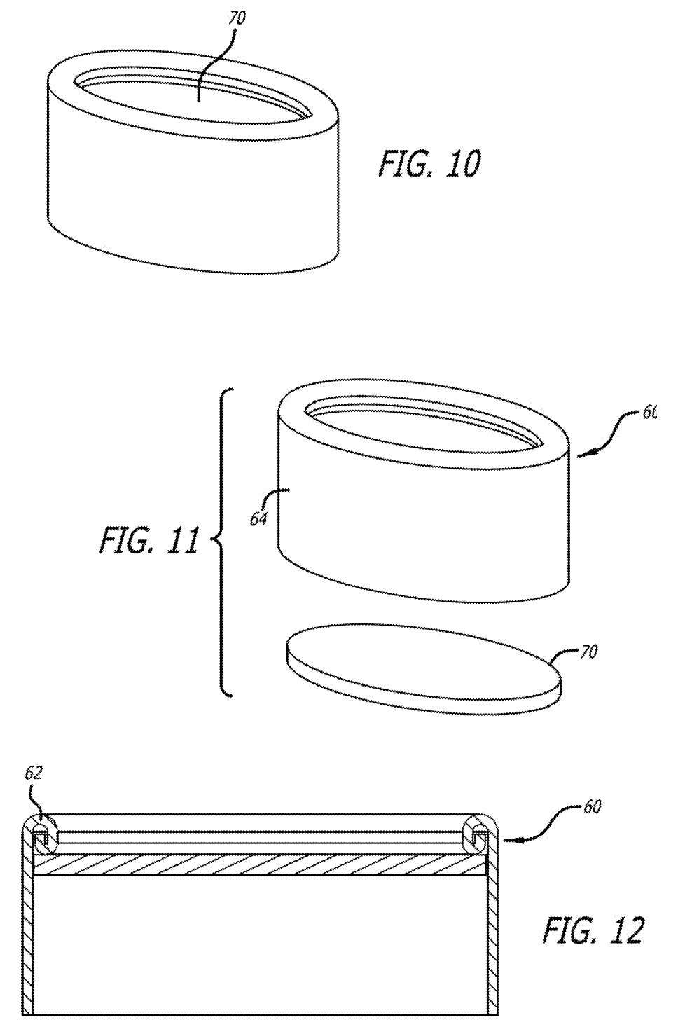

FIGS. 10-12 show an embodiment of cap 60, which includes an outer cap 64 and an inner plate 70. Outer cap 64 and inner plate 70 are preferably formed at least in part from a paper fiber material including wound paper fiber, cardboard, corrugated cardboard, and cellulose, with at least a portion of the materials preferably being made from postconsumer paper, and is repulpable and recyclable.

Outer cap 64 is a formed shell with a top edge rolled inward to form a hem 62. Inner plate 70 is formed to fit within outer cap 64 and secure to hem 62 through pressure fitting, mechanical bonding, thermal bonding, and/or adhesive or other known methods or materials suitable for the intended purpose. It is appreciated that cap 60 may be formed as a single piece, or configured to include additional components for its intended purpose.

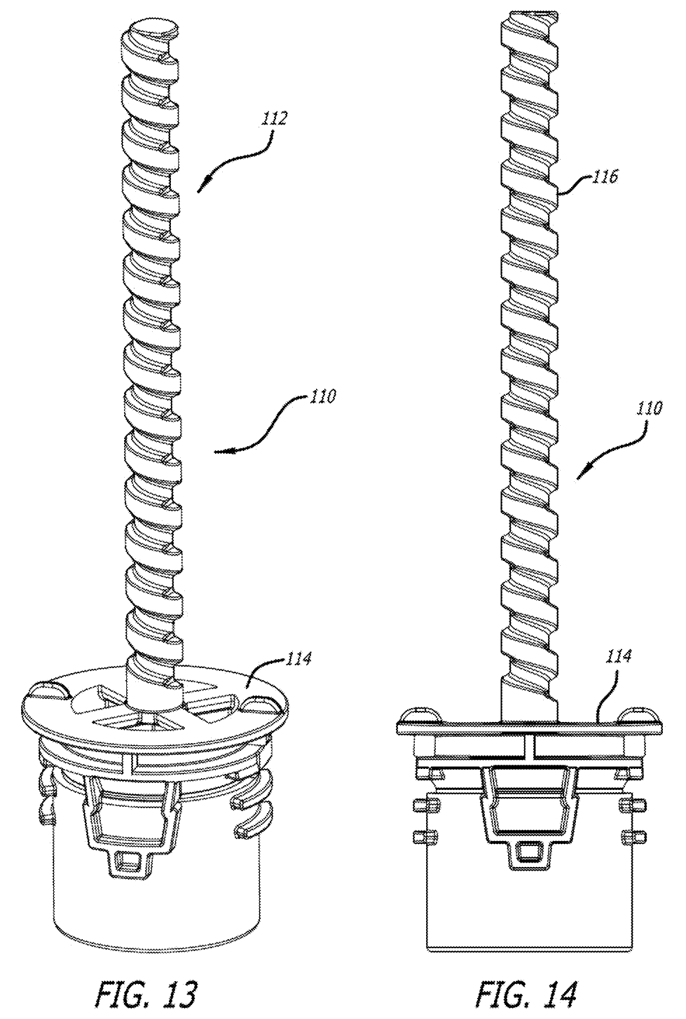

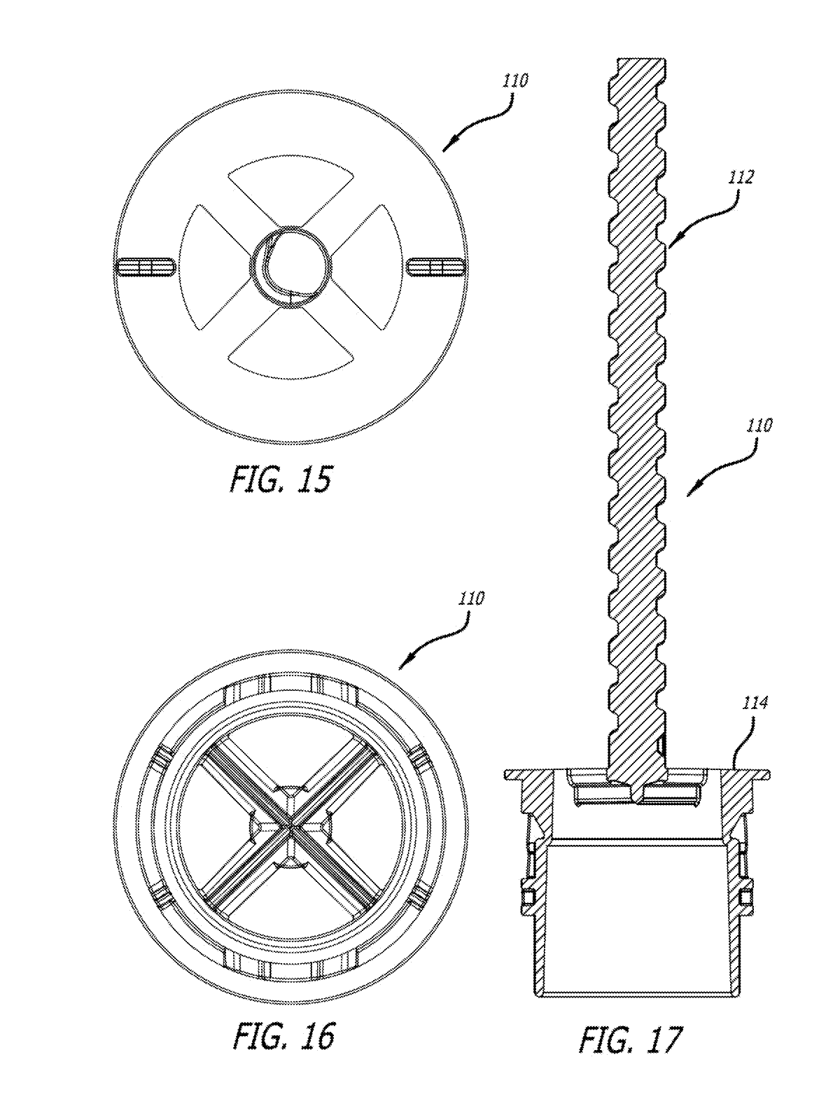

FIGS. 13-17 show an embodiment of spindle 110, which includes a rod 112 and a base 114. Rod 112 is sufficiently rigid to support deodorant material when it is filled into interior cavity 46 of container 100 and allowed to set and at least in part solidify around spindle 110. Rod 112 includes threads 116 which are preferably square-cut and widely spaced apart to preserve the relatively smoother surface between the troughs of the threads and to avoid sharp, leading edges that could damage the deodorant material. When assembled in container 100, base 114 of spindle 110 extends through seal 48, body plate stop 45, and upper base shell 13 to lock into, and rotatably connect with, snap 12 of base portion 22. Plug 19 shown in FIG. 2 is configured to cover the bottom of spindle 110. Rod 112 of spindle 110 extends upward through interior cavity 46 of body portion 40. Spindle 110 is preferably made of PHA, PHB and/or materials that are recyclable, compostable, and/or repulpable to enable curbside recycling/home composting of the entire container 100. Spindle 110 does not contain any contaminants, such as petroleum products or other synthetics, for example, that would prevent curbside recycling. Preferably, spindle 110 is molded as one piece, but it is appreciated that spindle 110 may be formed using multiple components.

Spindle 110 is preferably a component of elevator mechanism 82 along with platform 80, which holds and pushes the deodorant material upward to be dispensed from container 100. It is appreciated that the material being dispensed from container 100 need not be limited to a deodorant material and may include a solid or semi-solid formulation such as a deodorant, antiperspirant, foundation, sunscreen, and similar product.

FIGS. 24-29 show platform 80, which preferably includes a threaded aperture 86 configured to receive spindle 110. Platform 80 preferably is made of PHA, PHB and/or materials that are recyclable, compostable, and/or repulpable to enable curbside recycling/home composting of the entire container 100. Spindle 110 is threadably engaged via threads 116 to threaded aperture 86 and operates to move platform 80 along the length of spindle 110 when spindle 110 is rotated via base portion 22. Square-cut threads 116 threadably engage threaded aperture 86 of platform 80 and may engage the deodorant material in interior cavity 46 resulting in the rotational advancement of platform 80 and the deodorant material from within container 100 when spindle 110 is rotated via base portion 22. Base portion 22 provides structural stability and a soft form for the user to interact with when it is rotated to advance the deodorant material from within the container.

The materials of the deodorant containers of the present invention are not required to be separated from one another to be recycled in the mainstream. Materials used include, for example, wound paper fiber, cardboard, corrugated cardboard, and cellulose with at least a portion of the materials preferably being made from postconsumer paper. The various components of the deodorant container may be coated, laminated, combined or otherwise treated with biodegradable materials to prevent absorption by the components and/or leakage of the deodorant material from the container.

The container in accordance with the present invention was specifically designed to ensure the repulpability of the packaging. The selection of materials is carefully balanced to ensure that the entire package is repulpable, regardless of the type of liner used. By meeting these stringent standards, the tubular container enhances the efficiency and effectiveness of fiber recycling, supporting a more sustainable and recyclable packaging solution for cosmetic products and also provide structural stability and a soft form for the user to interact with.

Previous designs of all paper deodorant containers all proved to be too expensive and difficult to manufacture. The new design of the deodorant container in accordance with an embodiment of the present invention has some parts that are made of PHA, PHB, or other biocompostable material that can be injection molded and some parts that are made of paper. The weight of the paper is such that it is considered repulpable and recyclable. It is appreciated that PHA is technically not a plastic or a bioplastic; although some might call it that because of its moldability properties. PHA is created by microbes so it is a moldable bio-based material that can be molded like plastic, but it is microbial in origin. A product including PHA can be plastic free which is highly desirable for a sustainable package. It is intended to be within the scope of the present invention, that the small parts of the container be made of PHA, PHB, or other similar moldable material that is home compostable.

As a result, the small PHA parts of the container are fully compostable and . plastic free. This combination of paper parts and PHA parts gives the container of the present invention a unique sustainability profile in that it can be both recyclable and home compostable and far simpler to manufacture.

If the entire container were to be made from PHA or plastic it would be very hard if not impossible to recycle. If it was made all out of PHA then it would be compostable but would be too expensive.

A novel aspect of the present invention is the combination of the materials in certain weights. For example, by keeping the amount of PHA below 15% of the total weight of the container, then that makes the container recyclable in the paper recycling stream and WMU repulpable. By making it from paper and PHA this makes it home compostable.

While the container of the present invention is described herein as a deodorant container, other containers for dispensing any solid formulation including lip balms, sunscreen, foundation or makeup are intended to be within the scope of the present invention. Also, while an embodiment of the container is shown as having an oval cross section, it is appreciated that the container also be generally cylindrical or have any other configuration and cross-sectional shape suitable for the intended purpose.

The foregoing outlines features of several examples or embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various examples or embodiments introduced herein. Those of ordinary skill in the art should also realise that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of examples or embodiments are provided herein. The order in which some or all the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some examples or embodiments.

Moreover, "exemplary" is used herein to mean serving as an example, instance, illustration, etc., and not necessarily as advantageous. As used in this application, "or" is intended to mean an inclusive "or" rather than an exclusive "or". In addition, "a" and "an" as used in this application and the appended claims are generally be construed to mean "one or more" unless specified otherwise or clear from context to be directed to a singular form. Also, at least one of A and B and/or the like generally means A or B or both A and B. Furthermore, to the extent that "includes", "having", "has", "with", or variants thereof are used, such terms are intended to be inclusive in a manner similar to the term "comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above-described features (e.g., elements, resources, etc.), the terms used to describe such features are intended to correspond, unless otherwise indicated, to any features which performs the specified function of the described features (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or application.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the broad scope of the disclosure.

Other embodiments of the invention will be apparent to those skilled in the art from consideration of the specification and practice of the invention disclosed herein.

What is claimed is:

1. A sustainable deodorant container being compostable and recyclable, the deodorant container comprising:
a body having a wall defining an interior cavity, a top end, and an opposite bottom end, the top end being open and providing access to the interior cavity for receiving and storing a deodorant material, the wall being made of a paper-based material being at least one of repulpable and recyclable, the wall having an outer surface and an inner surface for contacting the deodorant material placed within the interior cavity, the inner surface including an impermeable biomaterial to prevent the deodorant material from penetrating the body;
a cap for closing the top end to protect the deodorant material contained within the interior cavity, the cap being made of the paper-based material and including an inner surface for contacting the deodorant material within the interior cavity, the inner surface of the cap including the impermeable biomaterial to prevent the deodorant material from penetrating the cap;
an elevator mechanism in the interior cavity for advancing the deodorant material within the interior cavity towards the opening at the top end of the container to dispense the deodorant material, the elevator mechanism including a platform for holding and pushing the deodorant material to be dispensed, the platform including a threaded aperture, the platform being made of a Polyhydroxyalkanoates (PHA) material being compostable and has a surface for contacting the deodorant material;
a spindle threadbly engaging the threaded aperture and operating to move the platform along the length of the spindle when the spindle is rotated, the spindle being made of the PHA material and is compostable; and
a dial at the bottom end of the body, the dial being connected to an end of the spindle and is used to rotate the spindle to operate the elevator mechanism for dispensing the deodorant material from within the interior cavity, the dial being made of the PHA material and is compostable.

2. The deodorant container of claim 1, wherein the impermeable biomaterial of the inner surface of the body includes at least one of PHA, (PHB (Polyhydroxybutyrate), PHBV (Polyhydroxybutyrate-co-valerate), PHO (Polyhydroxyoctanoate), copolymers, and microbially synthesized polymers.

3. The deodorant container of claim 1, wherein the impermeable biomaterial of the inner surface of the body includes at least one of a natural, biodegradable wax, oil, and sealant to prevent absorption of the deodorant material.

4. The deodorant container of claim 1, wherein the paper-based material is at least approximately 80% to 85% by weight of the total weight of the deodorant container and the PHA material is less than approximately 15% to 20% by weight of the total weight of the deodorant container.

5. The deodorant container of claim 1, wherein the paper-based material includes recoverable fibers through a repulping process.

6. The deodorant container of claim 1, wherein the paper-based materials of the body include at least one of cardboard, corrugated cardboard, and cellulose with at least a portion of the paper-based material preferably being made from postconsumer paper.

7. The deodorant container of claim 1, wherein the deodorant material is hydrous and the impermeable biomaterial prevents penetration of the deodorant material into the body.

8. The deodorant container of claim 1, wherein the deodorant material is anhydrous and the impermeable biomaterial prevents penetration of the deodorant material into the body.

9. The deodorant container of claim 1, wherein the PHA material includes at least one of PHB (Polyhydroxybutyrate), PHBV (Polyhydroxybutyrate-co-valerate), biodegradable biopolymer, PHO (Polyhydroxyoctanoate), microbially synthesized polymers, and/or materials that are recyclable, compostable, and/or repulpable to enable curbside recycling/home composting.

10. The deodorant container of claim 1, wherein the spindle includes threads with a square-cut configuration and widely spaced apart to preserve a relatively smoothe surface of the spindle between troughs of the threads, the square-cut threads threadably engage the threaded aperture of platform and engage the deodorant material resulting in the advancement of the platform and deodorant material from within container when the spindle is rotated.

11. The deodorant container of claim 1, where various components of the deodorant container comprise at least one of coated, laminated, combined or treated with the impermeable biodegradable materials to prevent absorption by the components and leakage of the deodorant material from the container.

12. A cosmetic product container being compostable and recyclable, the cosmetic product container comprising:
a body having a wall defining an interior cavity, a top end, and an opposite bottom end, the top end being open and providing access to the interior cavity for storing a cosmetic material, the cosmetic material being a solid or semi-solid formulation, the wall being made of a paper-based material being at least one of repulpable and recyclable and includes an inner surface contacting the cosmetic material within the interior cavity, the inner surface including an impermeable biomaterial to prevent the cosmetic material from penetrating the body;
a cap for closing the top end to protect the cosmetic material contained within the interior cavity, the cap being made of the paper-based material and including an inner surface for contacting the cosmetic material within the interior cavity, the inner surface of the cap including an impermeable biomaterial to prevent the cosmetic material from penetrating the cap;
an elevator mechanism in the interior cavity for advancing the cosmetic material within the interior cavity towards the opening at the top end of the container to dispense the cosmetic material, the elevator mechanism including a platform for holding and pushing the cosmetic material to be dispensed, the platform including a threaded aperture, the platform being made of a Polyhydroxyalkanoates (PHA) material being compostable and has a surface for contacting the cosmetic material;
a spindle threadbly engaging the threaded aperture and operating to move the platform along the length of the spindle when the spindle is rotated, the spindle being made of the PHA material that is compostable; and
a dial at the bottom end of the body, the dial being connected to an end of the spindle and is used to rotate the spindle to operate the elevator mechanism for dispensing the cosmetic material from within the interior cavity, the dial being made of the PHA material that is compostable.

13. The cosmetic product container of claim 12, wherein the impermeable biomaterial of the inner surface of the body includes at least one of PHA, (PHB (Polyhydroxybutyrate), PHBV (Polyhydroxybutyrate-co-valerate), PHO (Polyhydroxyoctanoate), copolymers, and microbially synthesized polymers.

14. The cosmetic product container of claim 12, wherein the impermeable biomaterial of the inner surface of the body includes at least one of a natural, biodegradable wax, oil, and sealant to prevent absorption of the deodorant material.

15. The cosmetic product container of claim 12, wherein the paper-based material is at least approximately 80% to 85% by weight of the total weight of the cosmetic product container and the PHA material is less than approximately 15% to 20% by weight of the total weight of the cosmetic product container.

16. The cosmetic product container of claim 12, wherein the paper-based material includes recoverable fibers through a repulping process.

17. The cosmetic product container of claim 12, wherein the cosmetic material is hydrous and the impermeable biomaterial prevents penetration of the cosmetic material into the body of the cosmetic product container.

18. The cosmetic product container of claim 12, wherein the cosmetic material is anhydrous and the impermeable biomaterial prevents penetration of the deodorant material into the body of the cosmetic product container.

19. The cosmetic product container of claim 13, wherein the PHA material includes at least one of PHB (Polyhydroxybutyrate), PHBV (Polyhydroxybutyrate-co-valerate), biodegradable biopolymer, PHO (Polyhydroxyoctanoate), microbially synthesized polymers, and/or materials that are recyclable, compostable, and/or repulpable to enable curbside recycling/home composting.

20. The cosmetic product container of claim 1, wherein the spindle includes threads with a square-cut configuration and widely spaced apart to preserve a relatively smoothe surface of the spindle between troughs of the threads, the square-cut threads threadably engage the threaded aperture of platform and engage the cosmetic material resulting in the advancement of the platform and cosmetic material from within container when the spindle is rotated.
